(19) United States
(12) Patent Application Publication
(10) Pub. No.: US 2011/0233814 A1
(43) Pub. Date: Sep. 29, 2011

(54) Extrusion Molding Method of Resin-Molded Article and Resin Extrusion Molding Apparatus

(75) Inventors: Koji Matsuda, Toyama (JP); Seiji Makino, Toyama (JP)

(73) Assignee: YKK Corporation, Tokyo (JP)

(21) Appl. No.: 13/071,554

(22) Filed: Mar. 25, 2011

(30) Foreign Application Priority Data
Mar. 26, 2010 (JP) 2010-072492

(51) Int. Cl. B29C 47/08

(52) U.S. Cl. 264/151; 425/113

(57) ABSTRACT

An extrusion molding method of a resin-molded article is provided. A resin extrusion molding apparatus includes an extruder, a die, a sizing device, a take-up device and a cutting machine. During the resin-molded article is extrusion-molded, a replacement die is made to stand by at a standby position laterally adjacent to the die and a replacement sizing unit is made to stand by at a standby position laterally adjacent to a sizing unit which coincides with an extrusion line of the sizing device. After the resin extrusion molding apparatus is stopped, the die is detached from the extruder and the replacement die is moved to and attached to the extruder, and the sizing unit is moved to a position laterally deviated from the extrusion line and the replacement sizing unit is moved to a position which coincides with the extrusion line. Upper and lower endless rotary bodies of the take-up device are laterally moved to make one of a plurality of supporting faces of pads coincide with the extrusion line. After the replacement of the die, the replacement of the sizing device and the replacement of the take-up device are completed, the resin extrusion molding apparatus is restarted.

The disclosure of Japanese Patent Application No. 2010-072492 filed on Mar. 26, 2010, including a specification, drawings and claims is incorporated herein by reference in its entirety.

### BACKGROUND

The present invention relates to an extrusion molding method of resin-molded articles, such as a resin material for a resin sash and a gasket for the attachment of glass, and a resin extrusion molding apparatus for implementing the method.

Various kinds of apparatuses which extrusion-mold resin-molded articles have been suggested.

For example, as disclosed in Patent Document 1, a resin extrusion-molding apparatus is suggested in which an extruder, an extrusion-molding die (die), a sizing device, a take-up machine, and a cutting machine are sequentially installed along an extrusion line.

An extrusion molding method using the aforementioned resin extrusion molding apparatus is adapted to pass the resin melted and kneaded in the extruder through the die, thereby continuously extrusion-molding a resin-molded article, cool and mold the extruded resin-molded article in the sizing device to solidify the article to a predetermined dimension and shape, take up the resin-molded article in the take-up device; and cut the resin-molded article into a predetermined length in the cutting machine. In a case where resin molded articles having different shapes are extrusion-molded, the resin extrusion molding apparatus is stopped if the extrusion molding of an old resin-molded article has ended, setting up of the resin extrusion molding apparatus is performed so that a new resin-molded article can be extrusion-molded, and then, the resin extrusion molding apparatus is operated to extrusion-mold a new resin-molded article having a different shape as described above.
[Patent Document 1] JP-A-9-117955

For the setup of the resin extrusion molding apparatus described above, there are a replacement task of detaching an old die and attaching a new die, cooling of the sizing device, a sizing die replacement task of detaching a sizing die for molding and attaching a new sizing die, a pad replacement task of detaching a pad of the take-up device and attaching a pad corresponding to the outer peripheral shape of a new resin-molded article, and the like.

Since the aforementioned individual replacement tasks is complicated and requires substantial time and effort, a long time is taken for the setup of the rein extrusion molding apparatus and the resin extrusion molding apparatus is paused for an extended period. Therefore, the efficiency of an extrusion molding task is poor.

In general, the aforementioned extruder melts, kneads, and compresses a charged resin material, extrudes the resin material toward a die, and passes the resin material through the die, thereby performing extrusion molding. Although there is no problem when the extruder is continuously operated, the resin within the extruder may deteriorate if the extruder is paused for a predetermined time or longer. Thus, when the extruder is operated again, the resin within the extruder should be removed.

If a long time is taken for the setup as mentioned above, the pause time of the extruder is long, and the resin within the extruder should be removed when the extruder is operated again. The task is troublesome, and the resin is wasted.

The aforementioned deterioration of the resin occurs strikingly in a case where the resin material is PVC resin.

### SUMMARY

It is therefore an object of at least one embodiment of the present invention to provide a extrusion molding method of a resin-molded article which can shorten the pause time when resin-molded articles having different shapes are extrusion-molded, thereby improving the efficiency of the extrusion molding task and can perform extrusion molding without removing the resin within the extruder, and a resin extrusion molding apparatus for implementing the method.

In order to achieve the above-described object, according to an aspect of the embodiments of the present invention, there is provided an extrusion molding method of a resin-molded article, using a resin extrusion molding apparatus including an extruder 1, a die 2, a sizing device 3, a take-up device 4 and a cutting machine 5, the extrusion molding method comprising: melting resin in the extruder 1; molding the melted resin through the die 2 to form the resin-molded article; forming the resin-molded article into a predetermined dimension and a predetermined shape in the sizing device 3; then taking up the resin-molded article in the take-up device 4; and then cutting the resin-molded article into a predetermined length in the cutting machine 5, wherein during the resin-molded article is extrusion-molded, a replacement die 2a is made to stand by at a standby position laterally adjacent to the die 2 attached to the extruder 1 and a replacement sizing unit 36 is made to stand by at a standby position laterally adjacent to a sizing unit 35 which coincides with an extrusion line a of the sizing device 3, wherein after the resin extrusion molding apparatus is stopped, the die 2 is detached from the extruder 1 and the replacement die 2a is moved to and attached to the extruder 1, thereby performing replacement of the die, and the sizing unit 35 is moved to a position laterally deviated from the extrusion line a and the replacement sizing unit 36 is moved to a position which coincides with the extrusion line a, thereby performing replacement of the sizing device 3, wherein upper and lower endless rotary bodies 41 of the take-up device 4 are laterally moved to make one of a plurality of supporting faces 40a of pads 40 coincide with the extrusion line a, thereby performing replacement of the take-up device 4, and wherein after the replacement of the die, the replacement of the sizing device 3 and the replacement of the take-up device 4 are completed, the resin extrusion molding apparatus is restarted to extrusion-mold a resin-molded article.

According to the extrusion molding method of a resin-molded article, the replacement of the die, the replacement of the sizing device 3, and the replacement of the take-up device 4 can be performed in a short time, respectively, and the setup which allows resin-molded articles having different shapes to be extrusion-molded can be performed in a short time. Therefore, the pause time of the resin extrusion molding apparatus can be shortened.

Accordingly, the efficiency of extrusion molding task of resin-molded articles can be improved, the extrusion molding can be performed without removing the resin within the extruder 1, and the resin is not wasted.

In the extrusion molding method, the die 2 attached the extruder 1 may be supported by a first die supporting member 22 and moved to a standby position together with the first die supporting member 22 and the replacement die 2a may be supported by a second die supporting member 23 and moved to the extruder 1 together with the second die supporting member 23.

With this configuration, the die 2 and the replacement die 2a can be moved by moving the first and second die supporting members 22 and 23. Therefore, the die replacement can be performed in a shorter time.

In the extrusion molding method, the sizing unit 35 and the replacement sizing unit 36 of the sizing device 3 may be laterally moved in conjunction with each other such that the replacement sizing unit 36 moves to the position which coincides with the extrusion line a when the sizing unit 35 moves to the position deviated from the extrusion line a.

With this configuration, replacement of the sizing device 3 can be performed in a shorter time.

In the extrusion molding method, when a height of the extrusion line a varies depending on a shape of a resin-molded article, the replacement sizing unit 36 may be vertically moved at the time of replacement of the sizing device 3 so as to match the height of the extrusion line a.

With this configuration, even if the height of the extrusion line a varies, the replacement sizing unit 36 can be matched to the height thereof.

According to another aspect of the embodiments of the present invention, there is provided a resin extrusion molding apparatus comprising an extruder 1, a die 2, a sizing device 3, a take-up device 4 and a cutting machine 5 which are provided sequentially along an extrusion line a, wherein the resin extrusion molding apparatus is provided with a die replacing device 20 including a first die supporting member 22 which supports the die 2 and moves between an attachment position which faces the extruder 1 and one standby position, and a second die supporting member 23 which supports a replacement die 2a and moves between the attachment position and another standby position, wherein the sizing device 3 includes a frame 32 having a first unit attachment portion 33 and a second unit attachment portion 34 which are adjacent to each other in a lateral direction perpendicular to the extrusion line a, the frame 32 being laterally movable between a first position where the first unit attachment portion 33 coincides with the extrusion line a and a second position where the second unit attachment portion 34 coincides with the extrusion line a, wherein a sizing unit 35 is detachably attached to one of the first unit attachment portion 33 and the second unit attachment portion 34 and a replacement sizing unit 36 is detachably attached to the other of the first unit attachment portion 33 and the second unit attachment portion 34, wherein the take-up device 4 includes upper and lower endless rotary bodies 41 vertically facing each other and having pads 40 on outer peripheral surfaces thereof, and the pads 40 have a plurality of supporting faces 40a which support top face and bottom faces of resin-molded articles having different shapes, in the lateral direction, and wherein the upper and lower endless rotary bodies 41 are laterally movable such that one of the supporting faces 40a of the pads 40 coincides with the extrusion line a.

According to the resin extrusion molding apparatus, since the replacement die 2a can be moved along with the first die supporting member 22 and the second die supporting member 23, the die replacement task can be performed in a short time.

Additionally, by moving the frame 32 of the sizing device 3, the sizing unit 36 for replacement can be set to a position which coincides with the extrusion line a and the replacement of the sizing device 3 can be performed in a short time.

Additionally, by laterally moving the upper and lower endless rotary bodies 41 of the take-up device 4, the supporting faces 40a which sandwich the top face and bottom face of a resin-molded article to be extrusion-molded can be made to coincide with the extrusion line a, and the replacement of the take-up device 4 can be performed in a short time.

In the resin extrusion molding apparatus, the frame 32 of the sizing device 3 may be vertically movable.

With this configuration, when extrusion-molding resin-molded articles in which the height of the extrusion line a is different, the replacement sizing unit 36 can be vertically moved so as to be matched to the height of the extrusion line a.

### BRIEF DESCRIPTION OF THE DRAWINGS

In the accompanying drawings:

FIG. 1 is a plan view of a resin extrusion molding apparatus according to an embodiment of the present invention;

FIG. 2 is a side view of the resin extrusion molding apparatus according to the embodiment;

FIG. 3 is an enlarged view of a die replacing device taken along a line A-A in FIG. 1; and

FIG. 4 is an enlarged view of a take-up machine taken along a line B-B of FIG. 1.

### DETAILED DESCRIPTION OF THE EMBODIMENTS

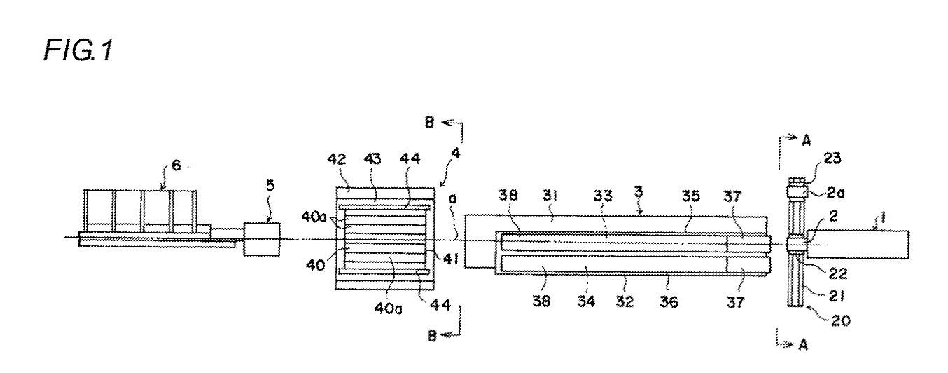

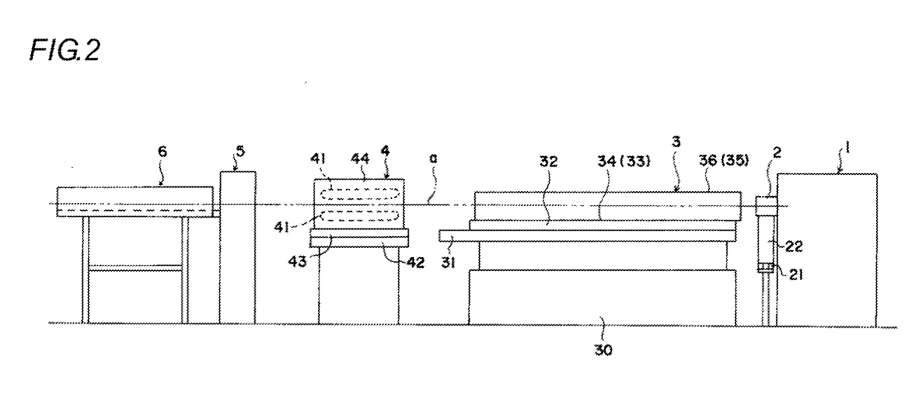

As shown in FIGS. 1 and 2, an extruder 1, an extrusion molding die 2, a sizing device 3, a take-up device 4, a cutting machine 5, and a run-out table 6 are sequentially installed on a floor surface or the like along an extrusion line a.

These constitute the resin extrusion molding apparatus of the invention.

The extruder 1 melts, kneads, and compresses charged resin (powder) using a screw to extrude the resin toward a die 2, and passes through the die 2 to continuously extrusion-mold a resin-molded article.

The extrusion line a is a line which extends toward the cutting machine 4 from the extruder 1 on the same line as a resin-molded article to be extrusion-molded and which is obtained by expressing a position determined by the extruder 1 and the die 2 with an imaginary line.

The die 2 is detachably attached to a front portion of the extruder 1.

The die 2 is replaced as the die is moved to an attachment position where the die is attached to the extruder 1 by a die replacing device 20, and standby positions on both sides of this attachment position.

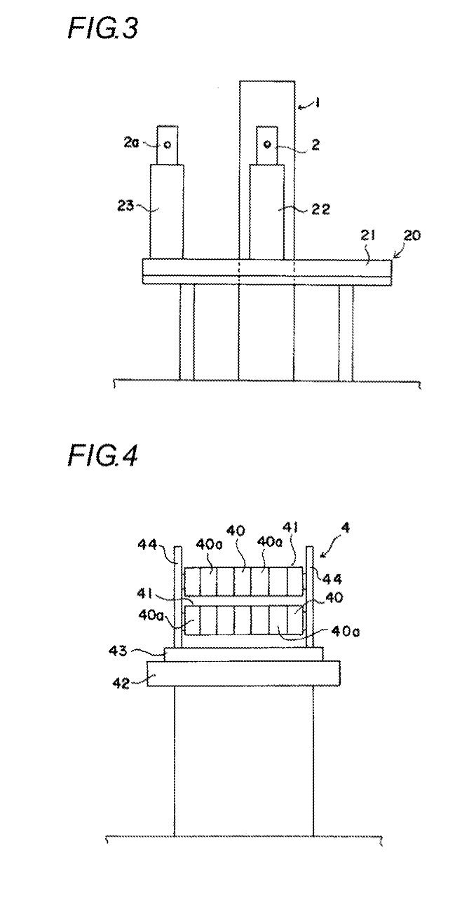

As shown in FIG. 3, the die replacing device 20 includes a guide portion 21 orthogonal to the extrusion line a, and a first die supporting member 22 and a second die supporting member 23 which move in a direction orthogonal to the extrusion line a along the guide portion 21, and the first die supporting member 22 moves between the aforementioned attachment position and one standby position along the guide portion 21. The second die supporting member 23 moves between the other standby position and the attachment position.

In the illustrated state, the die 2 is supported by the first die supporting member 22, the first die supporting member 22 is moved to the attachment position, and the die 2 is attached to the extruder 1. The attachment position is a position on the extrusion line a.

The second die supporting member 23 is moved to the other standby position, a replacement die 2a for a resin-molded article to be subsequently extrusion-molded is supported, and the replacement die 2a is made to stand by at a position adjacent to the aforementioned die 2.

It is preferable that the aforementioned first and second die supporting members 22 and 23 be manually moved.

The die replacement is performed as follows.

The die 2 is detached from the extruder 1, and is moved to one standby position along with the first die supporting member 22.

Simultaneously with this, the die 2 can be replaced by moving the second die supporting member 23, which supports the replacement die 2a, to the attachment position, and attaching the replacement die 2a supported by the second die supporting member 23 to the extruder 1.

Additionally, the next die replacement can be prepared by detaching the die 2 supported by the first die supporting member 22 at one standby position and supporting the replacement die 2a of a resin-molded article to be subsequently extrusion-molded, after the die replacement is performed as described above.

In the sizing device 3, a main frame 31 is attached to a main body 30 so as to be movable in a vertical direction, and a frame 32 is moved to the main frame 31 so as to be movable in a lateral direction. The lateral direction is a direction orthogonal to the extrusion line a on the horizontal plane.

The frame 32 includes a plurality of unit attachment portions, for example, a first unit attachment portion 33 and a second unit attachment portion 34 adjacent to the lateral direction. The frame 32 is movable to a first position where the first unit attachment portion 33 coincides with the extrusion line a and the second unit attachment portion 34 deviates laterally from the extrusion line a, and a second position where the second unit attachment portion 34 coincides with the extrusion line a and the first unit attachment portion 33 deviates laterally from the extrusion line a.

A sizing unit 35 and a sizing unit 36 for replacement can be detachably attached to the first and second unit attachment portions 33 and 34.

The individual sizing units 35 and 36 includes a sizing die 37 and a water tank 38, respectively.

In the sizing die 37, a resin-molded article extrusion-molded through the die 2 is inserted through a frame member having a predetermined shape of a hole, is cooled and molded in that state, and solidified with predetermined dimension and shape.

The water tank 38 further cools the aforementioned solidified resin-molded article to a normal temperature.

In the state shown in FIG. 1, the frame 32 is at the first position, the sizing unit 35 coincides with the extrusion line a, the sizing unit 35 is an actual sizing unit to be used for actual sizing, and the sizing unit 36 for replacement deviates from the extrusion line a. That is, provided is a space which is laterally adjacent to the sizing unit 35 in which the second unit attachment portion 34 coincides with the extrusion line a and to which the sizing unit for replacement of a resin-molded article to be subsequently extrusion-molded is attached and stand by.

Also, by laterally moving the frame 32 to the second position from the state shown in FIG. 1 and making the sizing unit 36 for replacement coincide with the extrusion line a, the sizing unit 36 for replacement becomes an actual sizing unit, and the sizing unit 35 deviates from the extrusion line a.

In short, when the first unit attachment portion 33 of the frame 32 has coincided with the extrusion line a, the second unit attachment portion 34 becomes a space to which a sizing unit for replacement is attached. When the second unit attachment portion 34 of the frame 32 has coincided with the extrusion line a, the first unit attachment portion 33 becomes a space to which a sizing unit for replacement is attached.

For this reason, the sizing unit can be replaced by moving the frame 32 laterally from the state shown in FIG. 1 and making the sizing unit 36 for replacement coincide with the extrusion line a.

Additionally, the replacement of the next sizing unit can be prepared by detaching the sizing unit 35 from the first unit attachment portion 33 and attaching to the first unit attachment portion 33 a sizing unit for replacement of a resin-molded article to be subsequently extrusion-molded, after the replacement is performed as described above.

In the sizing device 3 shown in FIGS. 1 and 2, as the main frame 32 moves vertically, the sizing units 35 and 36 move vertically along with the frame 32, and the centers of the sizing units 35 and 36 varies vertically.

Accordingly, in a case where the height of the extrusion line a has varied depending on the shape of a extrusion-molded article, the vertical center of the sizing unit 36 for replacement can be made to match the height of the extrusion line a by moving the main frame 31 vertically. In addition, the frame 32 may be split into two such that each frame moves independently.

As shown in FIGS. 1, 2, and 4, the take-up device 4 includes a pair of upper and lower endless rotary bodies 41 and 41 which have pads 40, respectively, and rotate in a direction along the extrusion line a. By rotating the upper and lower endless rotary bodies 41 and 41, a resin-molded article is taken up with its top face and bottom face sandwiched by the upper and lower pads 40, and is moved toward the cutting machine 5. The pads 40 extend in a direction (lateral direction) orthogonal to the rotational direction thereof, and are shorter in the rotational direction than the lateral direction, and the endless rotary body 41 is formed by coupling together a plurality of the pads 40 so as to have an endless shape.

Since the lateral width (i.e., the dimension in the direction orthogonal to the extrusion line a) of the upper and lower endless rotary bodies 41 and 41 is significantly greater than the lateral width of a resin-molded article, the lateral width (the dimension in a direction perpendicular to the extrusion line a on the horizontal plane) of the upper and lower pads 40 is significantly greater than the lateral width of the resin-molded article, and a plurality of supporting faces 40a is provided in the lateral width direction so that the top faces and bottom faces of resin-molded articles having different shapes can be supported by the supporting faces 40a.

A number of the supporting faces 40a are disposed corresponding to resin-molded articles. For this reason, the lateral width is large.

The upper and lower endless rotary bodies 41 and 41 are movable in the lateral direction (direction orthogonal to the extrusion line a), and are adapted so that any one supporting face 40a can coincide with the extrusion line a.

For example, a horizontal frame 43 is attached to a machine bed 42 so as to be laterally movable, a pair of vertical frames 44 is attached to the horizontal frame 43, and the upper and lower endless rotary bodies 41 and 41 are rotatably attached between the pair of vertical frames 44.

Thereby, the upper and lower endless rotary bodies 41 and 41 can be laterally moved by laterally moving the horizontal frame 43.

The take-up device 4 laterally moves the upper and lower endless rotary bodies 41 and 41 such that the supporting face 40a of the pad 40 corresponding to a resin-molded article to be extrusion-molded by the die 2 coincides with the extrusion line a, when the die 2 is replaced as described above.

The lateral movement is performed by an electric motor, and depending on molding information of a resin-molded article, control and movement are made so as to bring the supporting face 40a matched with the information.

The cutting machine 5 cuts a resin-molded article conveyed by the take-up device 4 into a predetermined length.

The run-out table 6 takes out a resin-molded article cut by the cutting machine 5 laterally.

Next, a method for extrusion-molding a resin-molded article will be described.

A resin-molded article is extrusion-molded in a state where the die 2 corresponding to the resin-molded article to be extrusion-molded is attached to the extruder 1, the sizing unit of the sizing device 3 coincides with the extrusion line a and any one supporting face 40a of the take-up device 4 coincides with the extrusion line a.

For example, the die 2 supported by the first die supporting member 22 of the die replacing device 20 is attached to the extruder 1, and the sizing unit 35 coincides with the extrusion line a with the frame 32 of the sizing device 3 as the first position.

When the extrusion molding is performed as described above, the replacement die 2a of a resin-molded article to be subsequently extrusion-molded is made to stand by at a standby position laterally adjacent to the die 2 attached to the aforementioned extruder 1, and the sizing unit 36 for replacement is made to stand by at a standby position laterally adjacent to the sizing unit (actual sizing unit) 35 which coincides with the aforementioned extrusion line a.

For example, the replacement die 2a is supported by the second die supporting member 23 of the die replacing device 20 and stand by, and the sizing unit 36 for replacement is attached to the second unit attachment portion 34 of the frame 32 of the sizing device 3 and stands by.

The replacement die 2a is preferably heated and stands by. By doing so, the time for heating and temperature rising after being attached to the extruder 1 can be shortened.

When the aforementioned extrusion molding of a resin-molded article has ended, the extruder 1, the sizing device 3, and the take-up device 4 are stopped to pause the resin extrusion molding apparatus.

In this state, the die 2 attached to the aforementioned extruder 1 is detached, and the replacement die 2a which is standing by is moved an attached to the extruder 1 for die replacement.

For example, the die 2 is detached from the extruder 1, is moved to one standby position along with the first die supporting member 22, and the second die supporting member 23 is moved to the attachment position where the replacement die 2a is attached to the extruder 1 for die replacement.

For this reason, the die replacement can be performed in a short time.

Particularly, if the die replacing device 20 is utilized as described above, the die 2 and the replacement die 2a can be moved by moving the first and second die supporting members 22 and 23 along the guide portion 21, and the movement of the dies is easy. Therefore, the die replacement can be performed in a shorter time.

When the resin extrusion molding apparatus is paused, the sizing device 3 which coincides with the extrusion line a is moved to a position where the sizing unit 35 has deviated from the extrusion line a, and the sizing unit 36 for replacement which is standing by is moved to a position where the sizing unit for replacement coincides with the extrusion line a, and replacement of the sizing device 3 is performed.

For example, by laterally moving the frame 32 of the sizing device 3 to the second position, the sizing unit 35 which coincides with the extrusion line a is brought into a position deviated from the extrusion line a, and simultaneously, the sizing unit 36 for replacement is brought into a position which coincides with the extrusion line a in an interlocking manner.

For this reason, replacement of the sizing device 3 can be performed in a short time.

Particularly, if the sizing unit can be replaced by moving one frame 32 as mentioned previously, replacement of the sizing device 3 can be performed in a shorter time.

The height of the extrusion line a may vary depending on the shape of a resin-molded article to be subsequently extrusion-molded. Thus, in that case, the main frame 31 of the sizing device 3 is vertically moved, and the sizing unit 36 for replacement is vertically moved to match the vertical center thereof with the height of the extrusion line a.

As described above, when the resin extrusion molding apparatus is paused, the upper and lower endless rotary bodies 41 and 41 of the take-up device 4 is laterally moved, and the supporting face 40a corresponding to a resin-molded article to be subsequently extrusion-molded is made to coincide with the extrusion line a.

Since replacement of the take-up device 4 can be performed by moving the upper and lower endless rotary bodies 41 in this way, and therefore can be performed in a short time.

As described above, when the die replacement, the replacement of the sizing device 3, and the replacement of the take-up device 4 have ended, driving of the extruder, the sizing device, and the take-up device 4 is started to extrusion-mold a resin-molded article.

As mentioned previously, since the time for the die replacement, the replacement of the sizing device 3, and the replacement of the take-up device 4, i.e., the time for setting up the resin extrusion molding apparatus, so that resin-molded articles having different shapes can be extrusion-molded, is short, the pause time of the resin extrusion molding apparatus is short, and the efficiency of resin extrusion molding task improves.

Moreover, since the resin does not deteriorate within the extruder 1, the subsequent extrusion molding can be started in a state where the resin at the time of the previous extrusion molding has been filled into the extruder 1.

Accordingly, the troublesome task of removing the resin within the extruder 1 becomes unnecessary, and since the resin within the extruder 1 can be utilized for continuous extrusion molding, the resin is not wasted.

What is claimed is:

1. An extrusion molding method of a resin-molded article, using a resin extrusion molding apparatus including an extruder, a die, a sizing device, a take-up device and a cutting machine, the extrusion molding method comprising:
melting resin in the extruder;
molding the melted resin through the die to form the resin-molded article;
forming the resin-molded article into a predetermined dimension and a predetermined shape in the sizing device; then
taking up the resin-molded article in the take-up device; and then
cutting the resin-molded article into a predetermined length in the cutting machine,
wherein during the resin-molded article is extrusion-molded, a replacement die is made to stand by at a standby position laterally adjacent to the die attached to the extruder and a replacement sizing unit is made to stand by at a standby position laterally adjacent to a sizing unit which coincides with an extrusion line of the sizing device,
wherein after the resin extrusion molding apparatus is stopped, the die is detached from the extruder and the replacement die is moved to and attached to the extruder, thereby performing replacement of the die, and the sizing unit is moved to a position laterally deviated from the extrusion line and the replacement sizing unit is moved to a position which coincides with the extrusion line, thereby performing replacement of the sizing device,
wherein upper and lower endless rotary bodies of the take-up device are laterally moved to make one of a plurality of supporting faces of pads coincide with the extrusion line, thereby performing replacement of the take-up device, and
wherein after the replacement of the die, the replacement of the sizing device and the replacement of the take-up device are completed, the resin extrusion molding apparatus is restarted to extrusion-mold a resin-molded article.

2. The extrusion molding method as set forth in claim 1, wherein the die attached the extruder is supported by a first die supporting member and moved to a standby position together with the first die supporting member and the replacement die is supported by a second die supporting member and moved to the extruder together with the second die supporting member.

3. The extrusion molding method as set forth in claim 1, wherein the sizing unit and the replacement sizing unit of the sizing device are laterally moved in conjunction with each other such that the replacement sizing unit moves to the position which coincides with the extrusion line when the sizing unit moves to the position deviated from the extrusion line.

4. The extrusion molding method as set forth in claim 1, wherein when a height of the extrusion line varies depending on a shape of a resin-molded article, the replacement sizing unit is vertically moved at the time of replacement of the sizing device so as to match the height of the extrusion line.

5. A resin extrusion molding apparatus comprising an extruder, a die, a sizing device, a take-up device and a cutting machine which are provided sequentially along an extrusion line,
wherein the resin extrusion molding apparatus is provided with a die replacing device including a first die supporting member which supports the die and moves between an attachment position which faces the extruder and one standby position, and a second die supporting member which supports a replacement die and moves between the attachment position and another standby position,
wherein the sizing device includes a frame having a first unit attachment portion and a second unit attachment portion which are adjacent to each other in a lateral direction perpendicular to the extrusion line, the frame being laterally movable between a first position where the first unit attachment portion coincides with the extrusion line and a second position where the second unit attachment portion coincides with the extrusion line,
wherein a sizing unit is detachably attached to one of the first unit attachment portion and the second unit attachment portion and a replacement sizing unit is detachably attached to the other of the first unit attachment portion and the second unit attachment portion,
wherein the take-up device includes upper and lower endless rotary bodies vertically facing each other and having pads on outer peripheral surfaces thereof, and the pads have a plurality of supporting faces which support top face and bottom faces of resin-molded articles having different shapes, in the lateral direction, and
wherein the upper and lower endless rotary bodies are laterally movable such that one of the supporting faces of the pads coincides with the extrusion line.

6. The resin extrusion molding apparatus as set forth in claim 5, wherein the frame of the sizing device is vertically movable.
